(19) United States
(12) Patent Application Publication
(10) Pub. No.: US 2017/0337421 A1
(43) Pub. Date: Nov. 23, 2017

(54) BEVERAGE DISPENSER AND RECOMMENDED PRODUCT DISPLAY METHOD OF THE BEVERAGE DISPENSER

(71) Applicant: Panasonic Intellectual Property Management Co., Ltd., Osaka (JP)

(72) Inventors: Naoki YAMASAKI, Shiga (JP); Yasuhiro BAN, Saitama (JP); Shota NAKAJIMA, Kyoto (JP)

(21) Appl. No.: 15/590,184

(22) Filed: May 9, 2017

(30) Foreign Application Priority Data
May 18, 2016 (JP) 2016-099365

(51) Int. Cl. G06K 9/00; B67D 1/08; G06Q 30/02

(52) U.S. Cl. CPC G06K 9/00288; G06Q 30/0271; B67D 1/0877; G06K 2009/00322

(57) ABSTRACT

A beverage dispenser according to the present disclosure includes a display unit that displays a menu of beverages to be sold, a person detector that detects a person who selects at least one of the beverages, a person attribute determiner that determines attribute information on the person, recommended product determiner that determines a recommended product based on the attribute information, a display method determiner that determines, based on the attribute information, a display method of the recommended product to be displayed on the display unit, and a recommended product display controller that displays the recommended product on the display unit through the display method. Thus, a specific product can be displayed efficiently in a beverage dispenser to be used by an unspecified number of people.

### BACKGROUND

### 1. Technical Field

The present disclosure relates to a beverage dispenser including a touch panel display and to a recommended product display method of the beverage dispenser.

### 2. Description of the Related Art

Heretofore, an automatic vending machine has been known, which is installed in a shop or a facility, and includes a touch panel display. In such a conventional vending machine, a visually understandable display is made, and a user can intuitively select a product.

In the conventional automatic vending machine, products to be sold are displayed on one screen even when a number or types of the products are large. As a result, it is apprehended that the user may have trouble selecting a desired product.

Therefore, Unexamined Japanese Patent Publication No. 2012-63930 proposes an automatic vending machine, which estimates an age or gender of the user as attribute information, based on image information obtained by imaging means such as a camera, and displays a product, which corresponds to the estimated attribute information, as a recommended product on a display.

However, a beverage dispenser installed in a family restaurant, a convenience store or the like is used by an unspecified number of people. Therefore, even if the recommended product is highlighted based on the attribute information, the recommended product thus highlighted may look troublesome to a user of a certain age, or a reason for such recommendation may not be sufficiently conveyed to the user. As a result, the user does not feel favorable to the recommended product, and such a recommendation function intended as a useful function may have an adverse effect.

### SUMMARY

A beverage dispenser according to the present disclosure displays a recommended product through an expression method suitable for an attribute of a user. In this way, at least one of the recommended product and the reason for recommendation can be effectively provided to users of all ages, and this provision can effectively encourage the users to select the recommended product.

A beverage dispenser of the present disclosure includes a display unit that displays a menu of beverages to be sold, a person detector that detects a person who selects at least one of the beverages, a person attribute determiner that determines attribute information on the person, a recommended product determiner that determines a recommended product based on the attribute information, a display method determiner that determines, based on the attribute information, a display method of the recommended product to be displayed on the display unit, and a recommended product display controller that displays the recommended product on the display unit through the display method.

Moreover, a recommended product display method of a beverage dispenser according to the present disclosure includes detecting a person who selects a beverage, determining attribute information on the person, determining a recommended product based on the attribute information, determining based on the attribute information, a display method of the recommended product to be displayed on the display unit, and displaying the recommended product on the display unit through the display method.

The beverage dispenser of the present disclosure determines an attribute of a person who selects a beverage to display a recommended product through an expression method corresponding to the attribute of the user, and can thus effectively provide at least one of the recommended product and a reason for recommendation to users of all ages. This can effectively encourage the users to select the recommended product.

### BRIEF DESCRIPTION OF THE DRAWINGS

FIG. 1 is a schematic diagram of a beverage dispenser in a first exemplary embodiment of the present disclosure;

FIG. 2 is a control block diagram of an operation display unit of the beverage dispenser in the first exemplary embodiment of the present disclosure;

FIG. 3 is a flowchart in the first exemplary embodiment of the present disclosure;

FIG. 4 is a diagram illustrating an initial beverage menu image in the first exemplary embodiment of the present disclosure;

FIG. 5 is a diagram illustrating an image that displays recommended products in the first exemplary embodiment of the present disclosure;

FIG. 6 is a diagram illustrating an image that enlarges and displays the recommended products in the first exemplary embodiment of the present disclosure;

FIG. 7 is a diagram illustrating an image that animates the recommended products in the first exemplary embodiment of the present disclosure;

FIG. 8 is a diagram illustrating an image that displays detailed displays of the recommended products in the first exemplary embodiment of the present disclosure;

FIG. 9 is a control block diagram of an operation display unit of a beverage dispenser in a second exemplary embodiment of the present disclosure; and

FIG. 10 is a flowchart in the second exemplary embodiment of the present disclosure.

### DETAILED DESCRIPTION

Hereinafter, exemplary embodiments of the present disclosure will be described while referring to the drawings. Note that the present disclosure is not limited by the exemplary embodiments.

### First Exemplary Embodiment

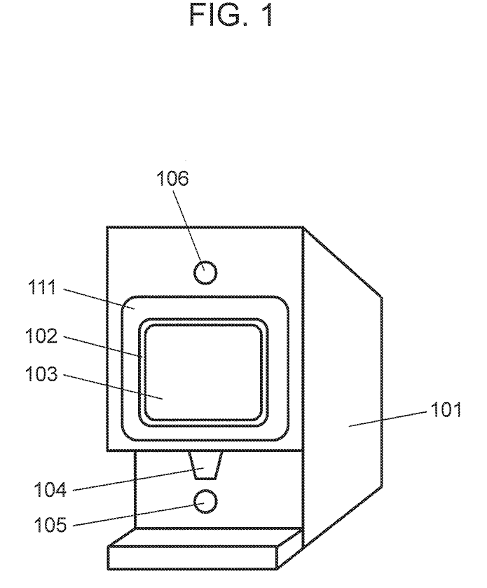

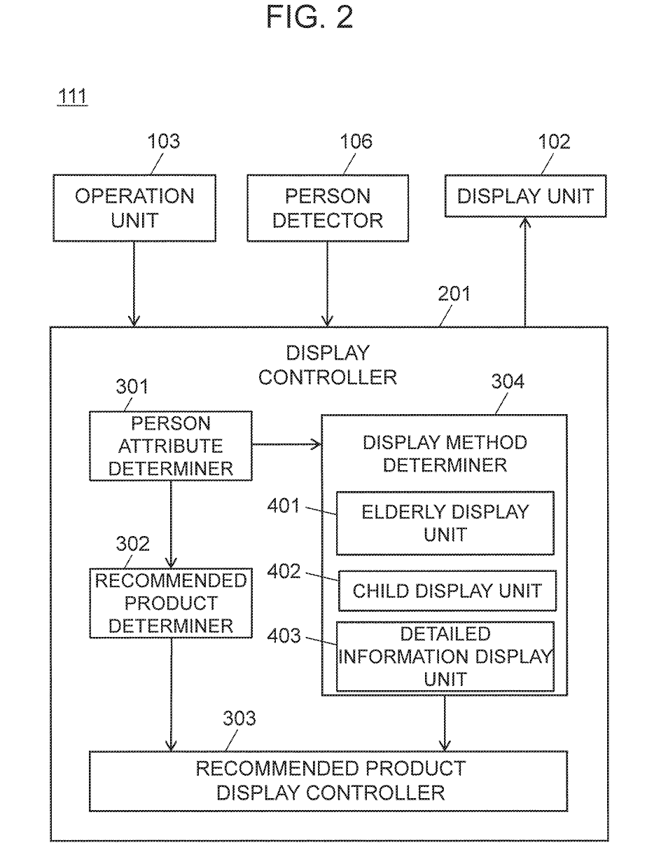

FIG. 1 illustrates a schematic diagram of an exterior appearance of a beverage dispenser in a first exemplary embodiment of the present disclosure. As illustrated in FIGS. 1 and 2, beverage dispenser 101 includes operation display unit 111. Operation display unit 111 has display unit (also referred to as a display) 102 including a matrix liquid crystal display for example, and operation unit 103 including a touch panel for example. Moreover, beverage dispenser 101 includes discharger 104 that discharges a beverage, cup detector 105 that detects whether a cup into which a beverage is discharged is placed in beverage dispenser 101, and person detector 106 that detects an approach of a person who uses beverage dispenser 101.

Operation unit 103 is formed from, for example, a capacitive touch panel including a pattern of electrodes arranged in a grid pattern. Operation unit 103 detects a pressed position of display unit 102.

Cup detector 105 is non-contact distance means. Cup detector 105 detects that a cup is placed at a position to which a beverage is discharged.

Person detector 106 is, for example, an imaging unit (also referred to as an image sensor) such as a camera. It is desirable that person detector 106 detects a person who is selecting a beverage in front of beverage dispenser 101.

FIG. 2 illustrates s a control block diagram of operation display unit 111 of the beverage dispenser in this exemplary embodiment. In FIG. 2, operation display unit 111 includes display unit 102 that displays a menu of beverages to be sold, operation unit 103 that causes a user to select a desired beverage via the touch panel, person detector 106 that detects the person who is selecting the beverage in front of the beverage dispenser, and display controller 201 that controls image display onto display unit 102.

Moreover, display controller 201 includes person attribute determiner 301, recommended product determiner 302, display method determiner 304, and recommended product display controller 303. Person attribute determiner 301 determines attribute information, such as an age and gender of a user, based on image information detected by person detector 106. Recommended product determiner 302 determines a product, which is to be recommended to the user, based on the attribute information determined by person attribute determiner 301. Display method determiner 304 determines a display method of such a recommended product, based on the attribute information determined by person attribute determiner 301. Recommended product display controller 303 displays the recommended product, which is determined by recommended product determiner 302, on the display unit 102 through the display method determined by display method determiner 304.

Display method determiner 304 includes elderly display unit 401, child display unit 402, and detailed information display unit 403. Elderly display unit 401 transmits information about a display method, which corresponds to a case where age information determined by person attribute determiner 301 is equal to or more than a preset first age, to recommended product display controller 303. Child display unit 402 transmits information about a display method, which corresponds to a case where the age information determined by person attribute determiner 301 is less than a preset second age, to recommended product display controller 303. Detailed information display unit 403 transmits information about a display method, which corresponds to a case where the age information determined by person attribute determiner 301 is within a preset age range, for example, is equal to or more than a third age to less than a fourth age, to recommended product display controller 303. For example, the first age is 60 years of age, the second age is 12 years of age, the third age is 20 years of age, and the fourth age is 50 years of age. Note that the third age may be set to an age equal to the second age. The fourth age may be set to an age equal to the first age.

The display methods corresponding to the respective pieces of age information and pieces of detailed information on products are preset in elderly display unit 401, child display unit 402, and detailed information display unit 403.

Moreover, recommended product information is preset in recommended product determiner 302. The recommended product information represents products to be recommended to the user of the beverage dispenser in response to the age information determined by person attribute determiner 301.

Note that display controller 201 may have any form as long as display controller 201 controls operation display unit 111. Display controller 201 may include a processing unit and a storage that stores a control program. An MPU and a CPU are illustrated as examples of the processing unit. A memory is illustrated as an example of the storage. The control program recorded in the storage is executed by the processing unit. Moreover, display controller 201 may be realized by hard logic. Such realization of display controller 201 through the hard logic is effective for enhancing a processing speed. Display controller 201 may include one semiconductor chip, or may physically include a plurality of semiconductor chips. When display controller 201 includes the plurality of semiconductor chips, the respective controls mentioned above may be individually realized by semiconductor chips different from one another.

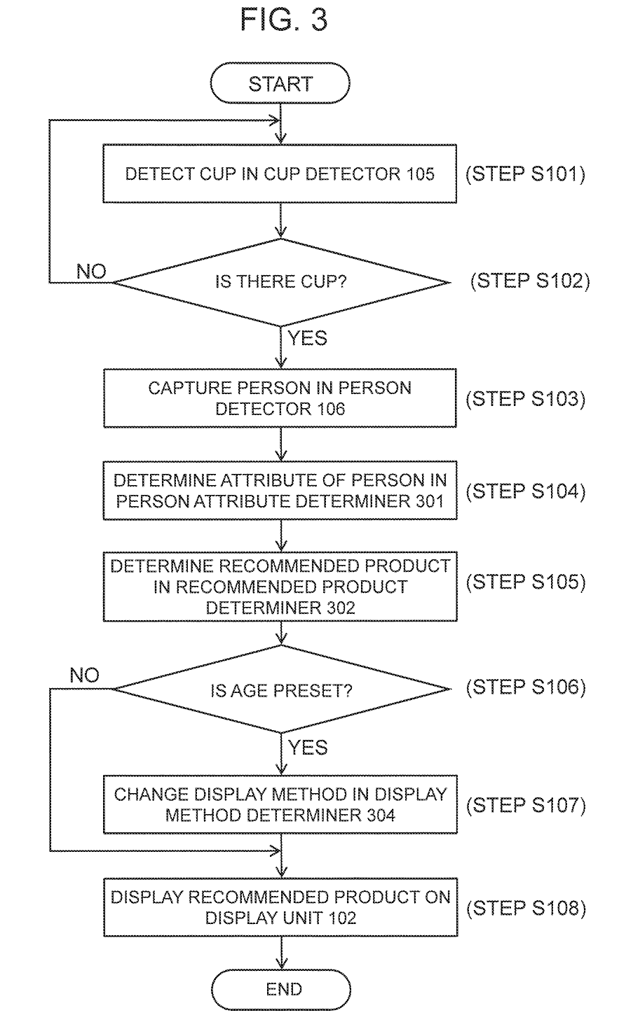

With regard to the operation of the beverage dispenser configured as described above, actions and functions of the operation concerned will be described with reference to a flowchart of FIG. 3.

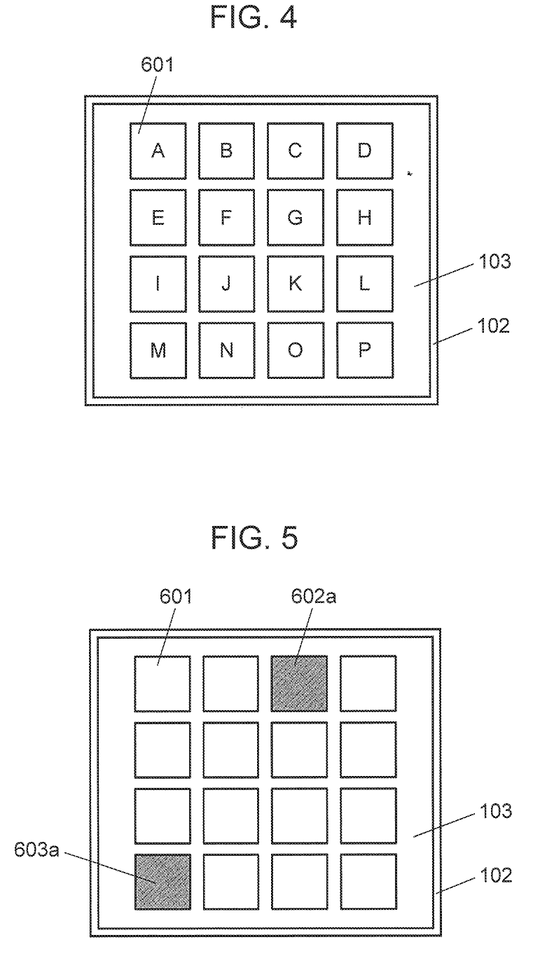

First, beverage dispenser 101 displays a beverage menu, which is illustrated in FIG. 4, on display unit 102 during standby. Then, cup detector 105 starts to detect whether a cup is present at a position where a beverage is supplied (step S101). “During standby” means a state where there is no user of the beverage dispenser, for example, a state where person detector 106 detects no person in front of beverage dispenser 101, or the user does not operate the operation unit 103.

Here, FIG. 4 illustrates an image example of the beverage menu displayed on display unit 102 during standby, in which beverage images 601 showing products A to P are displayed in a preset arrangement. Moreover, in beverage images 601, sizes of the respective images showing products A to P are substantially same sizes.

When the user approaches beverage dispenser 101 and places a cup at a predetermined position of beverage dispenser 101, cup detector 105 senses that the cup is placed (YES in step S102). Upon sensing that the cup is placed at the predetermined position, cup detector 105 notifies person detector 106 that the cup is placed.

Upon acquiring such information that the cup is placed from cup detector 105, person detector 106 captures a face image of the user who is selecting the beverage in front of beverage dispenser 101 (step S103), and transmits information on the captured face image to person attribute determiner 301.

Person attribute determiner 301 determines an age of the person, who is selecting the beverage, based on such face image information acquired from person attribute determiner 301 (step S104), and transmits the determined age information to recommended product determiner 302 and display method determiner 304.

Recommended product determiner 302 determines recommended products based on the age information acquired from person attribute determiner 301 (step S105). For example, recommended product determiner 302 determines product 602a and product 603a as such recommended products, and transmits information on the determined recommended products to recommended product display controller 303. For example, as illustrated in FIG. 5, recommended product display controller 303 changes a color or luminance of each of images, which correspond to the recommended products. In this case, it is desirable not to change sizes of the images, which correspond to the recommended products, since the user can also recognize products other than the recommended products with ease.

Display method determiner 304 determines whether the age information acquired from person attribute determiner 301 stays within the preset range, and changes the display method of the recommended products, based on the age information (step S107), when the age information stays within the preset range (YES in step S106).

For example, when the age information acquired from person attribute determiner 301 is equal to or more than the preset first age, display method determiner 304 transmits the information on the recommended products to elderly display unit 401. Moreover, when the age information acquired from person attribute determiner 301 is less than the preset second age, display method determiner 304 transmits the information on the recommended products to child display unit 402. Furthermore, when the age information acquired from person attribute determiner 301 is equal to or more than the preset third age to less than the preset fourth age, display method determiner 304 transmits the information on the recommended products to detailed information display unit 403.

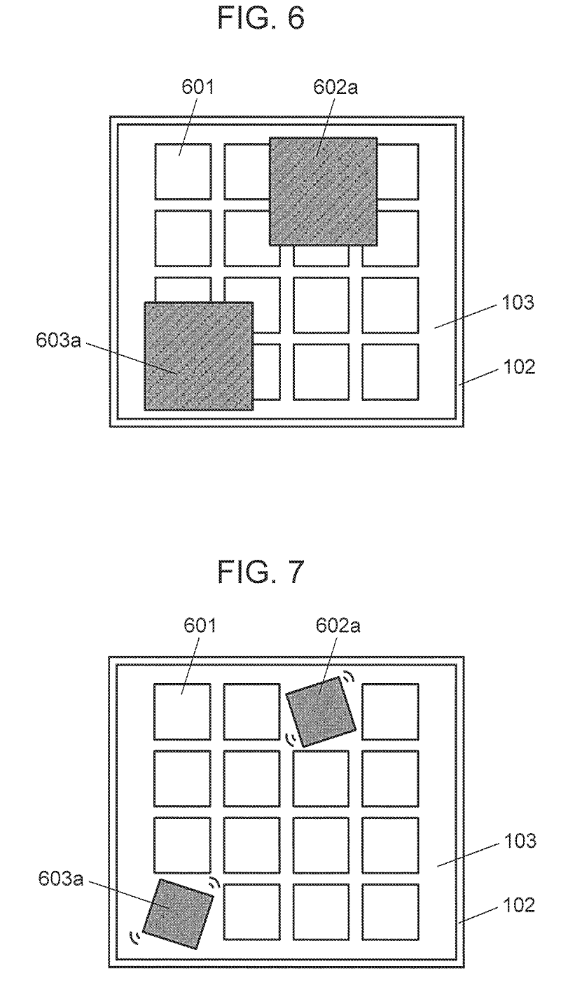

Elderly display unit 401 changes an instruction, which is issued to recommended product display controller 303, so as to display in an enlarged manner the product images of product 602a and product 603a, for example, as illustrated in FIG. 6. Such enlarged display is, for example, display for making the images, which correspond to the recommended products, larger than images, which correspond to other products. It is desirable that the sizes of the images, which correspond to the recommended products, be large enough to partially overlap the images, which correspond to the products other than the recommended products, in the arrangement displayed on display unit 102 during standby.

Child display unit 402 changes the instruction, which is issued to recommended product display controller 303, so as to animate the product images of the product 602a and product 603a, for example, as illustrated in FIG. 7. Such animation is, for example, display for intermittently rotating the images, which correspond to the recommended products, clockwise and counterclockwise in the figure, or to move the images left and right and up and down in the figure. In this case, it is desirable not to change sizes of the images, which correspond to the recommended products, since the user can also recognize products other than the recommended products with ease.

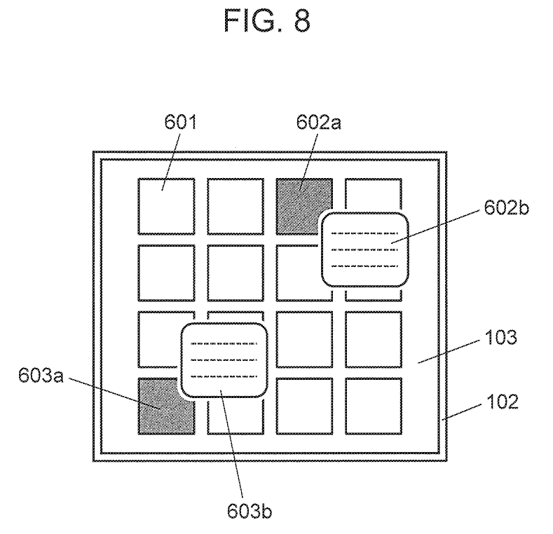

Detailed information display unit 403 changes the instruction, which is issued to recommended product display controller 303, so as to display detailed information 602b of product 602a and detailed information 603b of product 603a, for example, as illustrated in FIG. 8. The detailed information, which corresponds to the recommended products, is information on reasons for recommending the recommended products or information on the products themselves, such as calorie information and nutrition information on the recommended products. It is desirable that a size of images, which correspond to the recommended products, be large enough to partially overlap the images, which correspond to the products other than the recommended products, in the arrangement displayed on display unit 102 during standby since the detailed information can be recognized with ease.

Recommended product display controller 303 displays the recommended products, which are acquired from recommended product determiner 302, on display unit 102 based on the display method acquired from display method determiner 304 (step S108).

When cup detector 105 does not senses that a cup is placed (NO in step S102), the operation returns to step S101, and cup detector 105 periodically senses a cup.

When display method determiner 304 determines that the age information acquired from person attribute determiner 301 does not stay within the preset range (NO in step S106), the operation proceeds to step S108 without causing display method determiner 304 to change the display method of the recommended products. That is, the recommended products are displayed by the display method described with reference to FIG. 5.

As described above, in this exemplary embodiment, based on the age information on the person (the user) detected by person detector 106, the recommended products can be displayed by the display method suitable for each age. That is, the recommended products can be displayed by a method effective for users of all ages.

Moreover, in this exemplary embodiment, the images themselves of the recommended products are processed, and at least one of the enlarging display and animation of the images is performed. As a result, a capacity of a memory for storing the image data is suppressed, and the recommended products can be displayed effectively.

More specifically, when the age information acquired from person attribute determiner 301 is equal to or more than the preset first age, that is, when the user is an elderly, the recommended products are enlarged and displayed. As a result, it becomes easy for even the elderly to see the recommended products.

Moreover, when the age information is less than the preset second age, that is, when the user is a child, a child's interest can be attracted by animating the recommended products.

Moreover, when the age information is equal to or more than the preset third age to less than the fourth age, that is, when the user is an adult, the detailed information is added to the recommended products and displayed. As a result, information such as a reason for recommendation is provided to the user.

Note that the beverage dispenser may be connected to an external setting unit, and the recommended product information, which corresponds to the age information preset in recommended product determiner 302, may be set or changed via the external setting unit in an optional way. Furthermore, the age information, the display method, the detailed information on the product, or the like, which are preset for each of elderly display unit 401, child display unit 402 and detailed information display unit 403, may be set or changed in an optional way.

Moreover, in this exemplary embodiment, after the recommended products are displayed on display unit 102, when cup detector 105 senses that a cup is not placed, or when person detector 106 senses that no person is present in front of beverage dispenser 101, then the display of the recommended products on display unit 102 may be hidden. Accordingly, a next user can be prevented from selecting a product recommended for a previous user.

Note that, though this exemplary embodiment has been made on the assumption that a number of the recommended products are two, which are product 602a and product 603a, the number of the recommended products may be one or plural (two or more) products.

### Second Exemplary Embodiment

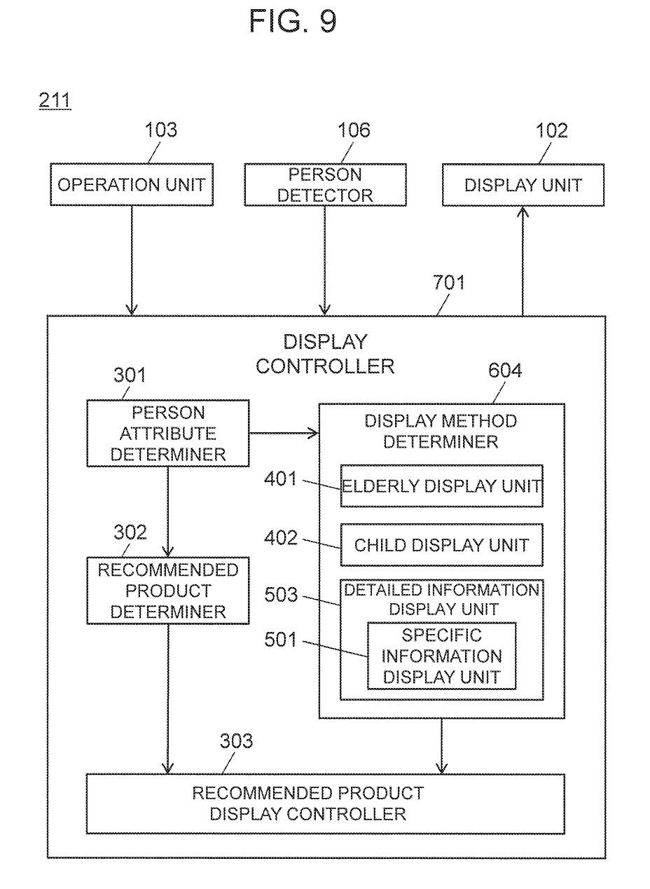

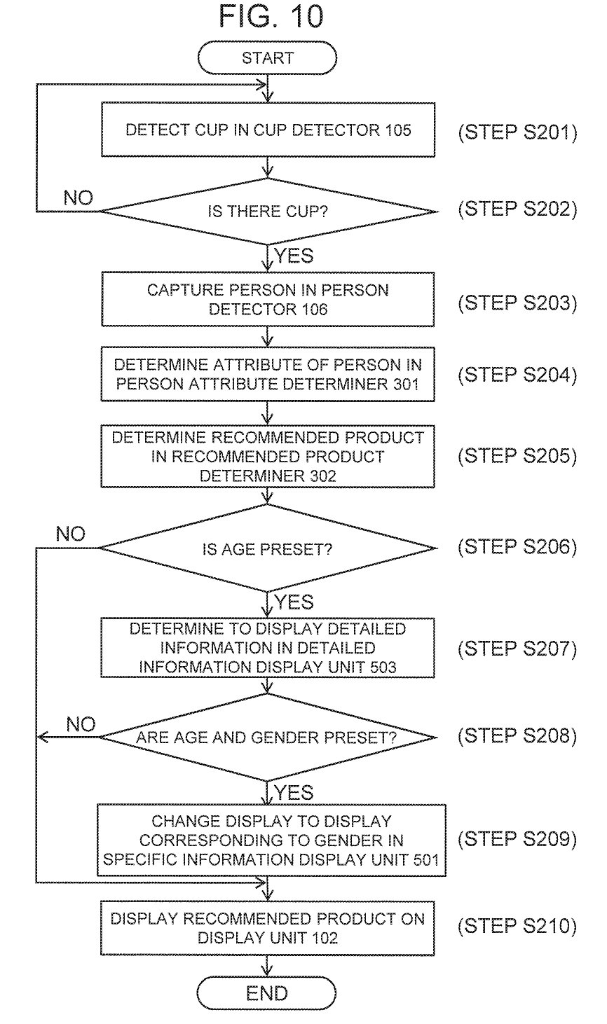

A second exemplary embodiment of the present disclosure will be described with reference to FIG. 9. FIG. 9 is a block diagram of an operation display unit of a beverage dispenser in this exemplary embodiment. Display controller 701 according to this exemplary embodiment is different from display controller 201 according to the first exemplary embodiment in that display controller 701 includes specific information display unit 501, which displays specific detailed information in response to gender information, in addition to the age information determined by person attribute determiner 301.

The following description refers to the beverage dispenser according to this exemplary embodiment while focusing on differences from the first exemplary embodiment.

Recommended product information is preset in recommended product determiner 302. The recommended product information represents products to be recommended to the user of the beverage dispenser in response to the age information and the gender information determined by person attribute determiner 301. In specific information display unit 501, detailed information on the products, which correspond to the age information and the gender information, is preset.

With regard to the operation of the beverage dispenser configured as described above, actions and functions of the operation concerned will be described with reference to a flowchart of FIG. 10.

First, beverage dispenser 101 displays the beverage menu, which is illustrated in FIG. 4, on display unit 102 during standby. Cup detector 105 then starts to detect whether a cup is present at a position where a beverage is discharged (step S201).

Here, FIG. 4 illustrates an image example of the beverage menu displayed on display unit 102 during standby, in which beverage images 601 showing products A to P are displayed in the preset arrangement.

When the user approaches beverage dispenser 101 and places the cup at a predetermined position of beverage dispenser 101, cup detector 105 senses that the cup is placed (YES in step S202). Upon detecting that the cup is placed at the predetermined position, cup detector 105 transmits a message that the cup is placed to person detector 106.

Upon acquiring such information that the cup is placed from cup detector 105, person detector 106 captures a face image of the user who is selecting the beverage in front of beverage dispenser 101 (step S203), and transmits information on the captured face image to person attribute determiner 301.

Person attribute determiner 301 determines an age and gender of the person, who is selecting the beverage, based on such face image information acquired from person detector 106 (step S204), and issues a notice about the age information and the gender information, which are thus determined, to recommended product determiner 302 and display method determiner 604.

Recommended product determiner 302 determines a recommended product based on the age information and the gender information, which are acquired from person attribute determiner 301 (step S205). For example, recommended product determiner 302 determines product 602a and product 603a as such recommended products, and issues a notice about information on the recommended products thus determined to recommended product display controller 303. For example, as illustrated in FIG. 5, recommended product display controller 303 changes a color or luminance of each of images, which correspond to the recommended products.

Display method determiner 604 determines whether the age information acquired from person attribute determiner 301 stays within the preset first age range. When the age information stays within the preset first age range (YES in step S206), display method determiner 604 determines that detailed information display unit 503 should display the detailed information on the products (step S207).

Moreover, display method determiner 604 determines whether the age information acquired from person attribute determiner 301 stays within the preset second age range, and whether the gender information acquired from person attribute determiner 301 coincides with a predetermined gender. When the age information stays within the preset second age range, and the gender information is a preset gender (YES in step S208), specific information display unit 501 changes display contents of the recommended products based on the age information and the gender information (step S209).

Note that the second age range may be set to an age equal to the first age range.

For example, when the age information determined by person attribute determiner 301 stays within the preset second age range, then as illustrated in FIG. 8, detailed information 602b of product 602a and detailed information 603b of product 603a are displayed near the product images. Furthermore, when the gender information determined by person attribute determiner 301 is female, calorie information on the recommended products is displayed in detailed information 602b and detailed information 603b.

Recommended product display controller 303 displays the recommended products, which are acquired from recommended product determiner 302, on display unit 102 based on the display method acquired from display method determiner 604 (step S210).

When cup detector 105 does not sense that a cup is placed (NO in step S201), the operation returns to step S201, and cup detector 105 periodically senses a cup.

When display method determiner 604 determines that the age information acquired from person attribute determiner 301 does not stay within the preset first age range (NO in step S206), the operation proceeds to step S210 without causing display method determiner 604 to change the display method of the recommended products based on the age information. That is, the recommended products are displayed by the display method described with reference to FIG. 5.

Moreover, when display method determiner 604 determines that the age information acquired from person attribute determiner 301 does not stay within the preset second age range, or that the gender information does not coincide with the preset gender (NO in step S208), the operation proceeds to step S210 without causing display method determiner 604 to change the display method of the recommended products based on the age information and the gender information. That is, the recommended products are displayed by the display method described with reference to FIG. 5.

As described above, the beverage dispenser according to this exemplary embodiment displays the information on the recommended products suitable for the user based on the age information and gender information on the person (the user) detected by person detector 106. That is, the recommended products are displayed by a method more effective for the user. Moreover, in response to the gender of the person, detailed information with such a content that interests the person concerned is imparted to each of the recommended products.

Note that beverage dispenser 101 may be connected to an external setting unit, and the recommended product information, which corresponds to the age information and the gender information, both of which are preset in recommended product determiner 302, may be set or changed via the external setting unit in an optional way. Moreover, at least one of the age information, the gender information, and the detailed information on the products corresponding to the age information and the gender information, all of which are preset in specific information display unit 501, may be set or changed via the external setting unit in an optional way.

Moreover, after the recommended products are displayed on display unit 102, when cup detector 105 senses that the cup is not placed, or when person detector 106 senses that no person is present in front of beverage dispenser 101 according to this exemplary embodiment, beverage dispenser 101 may hide the display of the recommended products on display unit 102.

As described above, beverage dispenser 101 according to a first aspect includes display unit 102 that displays a menu of beverages to be sold, person detector 106 that detects a person who selects at least one of the beverages, person attribute determiner 301 that determines attribute information on the person, recommended product determiner 302 that determines a recommended product based on the attribute information, display method determiner 304 that determines, based on the attribute information, a display method of the recommended product to be displayed on display unit 102, and recommended product display controller 303 that displays the recommended product on display unit 102 through the display method.

In this way, when the recommended product is displayed for the person who is selecting the beverage in front of beverage dispenser 101, the recommended product can be displayed by the display method corresponding to the attribute information on the person.

Beverage dispenser 101 according to a second aspect further includes cup detector 105 that detects a cup into which the beverage is poured. Person attribute determiner 301 determines the attribute information when cup detector 105 detects the cup.

In this way, person attribute determiner 301 determines the attribute of the person present in front of beverage dispenser 101 when cup detector 105 detects that the cup is placed, and accordingly, the recommended product can be displayed at timing when the user selects the recommended product.

In beverage dispenser 101 according to a third aspect, display method determiner 304 selects a display method for enlarging and displaying the recommended product when an age as the attribute information is equal to or more than a first age.

In this way, the recommended product can be enlarged and displayed when the person who is selecting the beverage in front of beverage dispenser 101 is an elderly.

In beverage dispenser 101 according to a fourth aspect, display method determiner 304 selects a display method for animating the recommended product when an age as the attribute information is less than a second age.

In this way, the recommended product can be animated when the person who is selecting the beverage in front of beverage dispenser 101 is a child.

In beverage dispenser 101 according to a fifth aspect, display method determiner 304 displays detailed information on the recommended product when an age as the attribute information is equal to or more than a third age and less than a fourth age.

In this way, the detailed information can be imparted to the recommended product and displayed when the person who is selecting the beverage in front of beverage dispenser 101 is a general adult.

In beverage dispenser 101 according to a sixth aspect, display method determiner 604 changes a content of the detailed information in response to a gender as the attribute information.

In this way, special information such as calorie information can be displayed as the detailed information on the recommended product in response to a gender of the person who is selecting the beverage in front of beverage dispenser 101.

In beverage dispenser 101 according to a seventh aspect, the recommended product is not displayed on display unit 102 when person detector 106 does not sense any person.

In this way, when the user disappears from the front of beverage dispenser 101 while the user is selecting the beverage, the recommended product can be hidden, and for the next user, such a recommended product with a wrong attribute is not displayed, so that a desirable beverage can be displayed.

A recommended product display method of beverage dispenser 101 according to an eighth aspect is a method including displaying a menu of beverages to be sold on display unit 102, detecting a person who selects a beverage, determining attribute information on the person, determining a recommended product based on the attribute information, determining, based on the attribute information, a display method of the recommended product to be displayed on display unit 102, and displaying the recommended product on display unit 102 through the display method.

As described above, the beverage dispenser according to the present disclosure determines the attribute of the person who is selecting the beverage, and displays the recommended product through an expression corresponding to the attribute of the user. Accordingly, the product is recommended to the user effectively, and the user can select a desired product in a short time. Therefore, the present disclosure can be applied also to an automatic vending machine for products, which is other than the beverage dispenser.

What is claimed is:

1. A beverage dispenser comprising:
a display unit that displays a menu of beverages to be sold;
a person detector that detects a person who selects at least one of the beverages;
a person attribute determiner that determines attribute information on the person;
a recommended product determiner that determines a recommended product based on the attribute information;
a display method determiner that determines, based on the attribute information, a display method of the recommended product to be displayed on the display unit; and
a recommended product display controller that displays the recommended product on the display unit through the display method.

2. The beverage dispenser according to claim 1, further comprising a cup detector that detects a cup into which the beverage is poured,
wherein the person attribute determiner determines the attribute information when the cup detector detects the cup.

3. The beverage dispenser according to claim 1, wherein the display method determiner selects a display method for displaying the recommended product in an enlarged manner when an age as the attribute information is equal to or more than a first age.

4. The beverage dispenser according to claim 1, wherein the display method determiner selects a display method for animating the recommended product when an age as the attribute information is less than a second age.

5. The beverage dispenser according to claim 1, wherein the display method determiner displays detailed information on the recommended product when an age as the attribute information is equal to or more than a third age and less than a fourth age.

6. The beverage dispenser according to claim 5, wherein the display method determiner changes a content of the detailed information in response to a gender as the attribute information.

7. The beverage dispenser according to claim 1, wherein the recommended product is not displayed on the display unit when the person detector does not sense a person.

8. A recommended product display method of a beverage dispenser, the recommended product display method for displaying a recommended product on a display unit, the recommended product display method comprising:
displaying a menu of beverages to be sold on the display unit;
detecting a person who selects a beverage;
determining attribute information on the person;
determining a recommended product based on the attribute information;
determining, based on the attribute information, a display method of the recommended product to be displayed on the display unit; and
displaying the recommended product on the display unit through the display method.
